(19) United States
(12) Patent Application Publication
(10) Pub. No.: US 2025/0231385 A1
(43) Pub. Date: Jul. 17, 2025

(54) OPTICAL GLASS MODULE AND SNOOT

(71) Applicant: Hongjie Chen, Shenzhen (CN)

(72) Inventors: Hongjie Chen, Shenzhen (CN); Wei Ma, Shenzhen (CN)

(21) Appl. No.: 18/744,699

(22) Filed: Jun. 17, 2024

(30) Foreign Application Priority Data
Jan. 12, 2024 (CN) 202420089098.1

(51) Int. Cl. G02B 19/00; G02B 7/02

(52) U.S. Cl. CPC G02B 19/0014; G02B 7/021; G02B 7/022; G02B 7/028

(57) ABSTRACT

The present invention is in the field of optical glass and particularly relates to an optical glass module including: a first lens for being close to a light source to focus light rays from the light source; and a second lens for focusing light rays passing through the first lens; the positions of the first lens and the second lens corresponding to each other; and a light-focusing path being formed from the first lens to the second lens. In the present invention, light rays at a light source are focused by a first lens, and the focused light rays are focused a second time by a second lens; the illumination effect of the light source is better after the light source is focused by the first lens and the second lens twice.

### CROSS REFERENCE TO RELATED APPLICATIONS

The present application claims the benefit of Chinese Patent Application No. 202420089098.1 filed on Jan. 12, 2024, the contents of which are incorporated herein by reference in their entirety.

### TECHNICAL FIELD

The present invention is in the field of optical glass and particularly relates to an optical glass module.

### BACKGROUND ART

When the light source irradiates, in order to concentrate the light rays so as to improve the irradiation effect, optical glass is often provided to focus light. Most of the optical glass used for focusing light is a convex lens. However, when the light source irradiates the convex lens to focus light, there is a light deviation that cannot irradiate the convex lens, thereby affecting the irradiation effect.

### SUMMARY OF THE INVENTION

In order to solve the above-mentioned problems, the present invention provides an optical glass module, which can focus light from a light source and effectively ensure the irradiation effect of the light source.

In order to achieve the above object, the technical solution of the present invention is as follows.

An optical glass module including:
a first lens for being close to a light source to focus light rays from the light source;
a second lens for focusing light rays passing through the first lens;
the positions of the first lens and the second lens corresponding to each other; and a light-focusing path being formed from the first lens to the second lens.

In the optical glass module, light rays at a light source are focused by a primary lens, and the focused light rays are focused a second time by a secondary lens; the illumination effect of the light source is better after the light source is focused by the primary lens and the secondary lens twice.

Further, the first lens and the second lens are convex lenses.

Further, two sides of the first lens are respectively a convex surface of the first lens and a plane of the first lens close to the light source; two sides of the second lens are respectively a convex surface of the second lens and a plane of the second lens; the convex surface of the first lens corresponds to the plane of the second lens.

Further, the optical glass module further includes a condenser lens tube having a light-focusing channel provided therein, wherein both the first lens and the second lens are provided in the light-focusing channel.

Further, the light-focusing channel increases in diameter from the first lens to the second lens.

A snoot including an imaging negative film, a mounting tube, and the optical glass module, wherein a mounting channel is provided in the mounting tube, one end of the mounting channel is sleeved on one end of the condenser lens tube, the imaging negative film is provided in the mounting tube, and the light-focusing path passes through the mounting channel and through the imaging negative film.

In the optical glass module, light rays at a light source are focused by a primary lens, and the focused light rays are focused a second time by a secondary lens, and the light rays focused by the second focusing pass through an imaging negative film to perform imaging; in the process, the imaging effect of the light rays emitted from the snoot is better based on the twice light focusing of the light source through the primary lens and the secondary lens.

Further, the imaging negative film is provided with a projected pattern of a plurality of through-holes.

Further, the condenser lens tube includes a lampshade and a lens tube, the light-focusing channel is provided in the lens tube, the lampshade channel is provided in the lampshade, and the lens tube is provided in the lampshade channel; one end of the mounting channel is sleeved on one end of the lampshade, the other end of the lampshade is formed with a light source port for providing a light source, and the light source port corresponds to the first lens.

Further, a plurality of lampshade heat dissipation holes penetrating to the lampshade channel are provided on the lampshade, and the plurality of lampshade heat dissipation holes surround the lampshade and all correspond to the lens tube.

Further, one end of the lampshade is provided with a first clamping end, one end of the mounting tube is provided with a second clamping end, a first clamping structure is provided at the first clamping end, a second clamping structure is provided at the second clamping end, the second clamping end is sleeved on the first clamping end, and the first clamping structure and the second clamping structure are detachably clamped; the first clamping end and the second clamping end are further provided with a quick release button for controlling the first clamping structure and the second clamping structure to be disengaged from clamping.

When the snoot is installed, the first clamping end and the second clamping end can be clamped with the second clamping structure by aligning the first clamping end and the second clamping end; when the snoot needs to be disassembled, the first clamping structure and the second clamping structure can be disengaged from clamping by pressing the quick release button, and then the first clamping end and the second clamping end can be disengaged; the disassembly and assembly process is more convenient, and the disassembly and assembly time can be effectively saved.

Further, the quick release button is movably provided on the second clamping end, wherein the quick release button passes through the second clamping end to connect with the first clamping structure.

Further, the first clamping structure includes an elastic clamping body, the elastic clamping body is provided with a clamping protrusion, the second clamping structure includes a clamping groove, the clamping protrusion is detachably clamped into the clamping groove, and the quick release button passes through the second clamping end and abuts the elastic clamping body to correspond to the position of the clamping protrusion. When the quick release button is pressed, the quick release button abuts the elastic clamping body so that the elastic clamping body is deformed, the clamping protrusion is disengaged from the clamping groove, and the first clamping end and the second clamping end can be separated.

Further, the quick release button includes a button part, an abutting part, and two limiting parts, wherein the two limiting parts are respectively fixedly provided at two ends of one side of the button part, and the abutting part is fixedly provided in the middle of one side of the button part; an abutting through-hole and two limiting through-holes are provided on the second clamping end, the abutting part passes through the abutting through-hole so as to abut the elastic clamping body, the two limiting parts are respectively movably provided in the two limiting through-holes, a first anti-releasing part to prevent the quick release button from disengaging from the second clamping end is provided on the limiting part, a second anti-releasing part is provided in the limiting through-hole, and the positions of the first anti-releasing part and second anti-releasing part correspond to each other. The two limiting parts can not only guide the movement of the quick release button on the second clamping end but also can limit the quick release button to be directly pulled out from the second clamping end based on the provision of the first anti-releasing part.

Further, a return spring is further provided between the button part and the second clamping end, the return spring is sleeved on the abutting part, and both ends of the return spring abut the button part and the second clamping end, respectively. The return spring serves to return the quick release button.

Further, the quick release button is made of a plastic material.

Further, the condenser lens tube includes a lampshade and a lens tube, the light-focusing channel is provided in the lens tube, the lampshade channel is provided in the lampshade, one end of the lens tube extends into the lampshade channel, and the lens tube is detachably connected to one end of the lampshade channel; the other end of the lampshade channel is formed with a light source port for providing a light source, and the light source port corresponds to the first lens;
and one end of the mounting channel is detachably sleeved on the other end of the lens tube via a threaded structure.

Further, a plurality of lampshade heat dissipation holes penetrating to the lampshade channel are provided on the lampshade, and the plurality of lampshade heat dissipation holes surround the lampshade and all correspond to the lens tube.

Further, the mounting tube is provided with an insertion slot therethrough to the mounting channel, and the imaging negative film is detachably inserted into the mounting channel through the insertion slot.

Further, an extended optical glass module is movably provided at the other end of the mounting channel. The extended lens of the extended optical glass module can be movably provided at the mounting channel by means of a thread or a guide rail, so as to adjust the imaging clarity projected on the background wall by moving and adjusting the distance from the imaging negative film.

Further, the extended optical glass module includes a third lens, a fourth lens, a fifth lens and a sixth lens; two sides of the third lens are respectively a third optical glass plane and a third optical glass convex surface; the fourth lens includes a fourth optical glass plane and a fourth optical glass convex surface; two sides of the fifth lens are both the fifth lens concave surfaces; two sides of the sixth lens are respectively a sixth optical glass plane and a sixth optical glass concave surface; the light-focusing path successively passes through the third optical glass plane, the third optical glass convex surface, the fourth optical glass convex surface, the fourth optical glass plane, the fifth optical glass concave surface on one side of the fifth lens, the fifth optical glass concave surface on the other side of the fifth lens, the sixth optical glass plane and the sixth optical glass convex surface.

An advantageous effect of the present invention is that in the optical glass module, light rays at a light source are focused by a first lens, and the focused light rays are focused a second time by a second lens; the illumination effect of the light source is better after the light source is focused by the first lens and the second lens twice.

### BRIEF DESCRIPTION OF THE DRAWINGS

FIG. 1 is a schematic view of the structure of a snoot of Example 1.

FIG. 2 is a sectional view B-B of FIG. 1.

FIG. 3 is a sectional view A-A of FIG. 1.

FIG. 4 is an optical path diagram of Example 1.

FIG. 5 is a schematic view of the structure of the imaged negative film of Example 1.

FIG. 6 is a schematic view of the structure of a snoot of Example 2.

FIG. 7 is a cross-sectional view of the snoot of Example 2.

FIG. 8 is an optical path diagram of Example 2.

FIG. 9 is a schematic view of the structure of the imaged negative film of Example 2.

### DETAILED DESCRIPTION OF THE INVENTION

In order that the objects, aspects, and advantages of the present invention will become more apparent, a more particular description of the invention will be rendered by reference to the embodiments thereof which are illustrated in the appended drawings. It should be understood that the particular embodiments described herein are illustrative only and are not limiting.

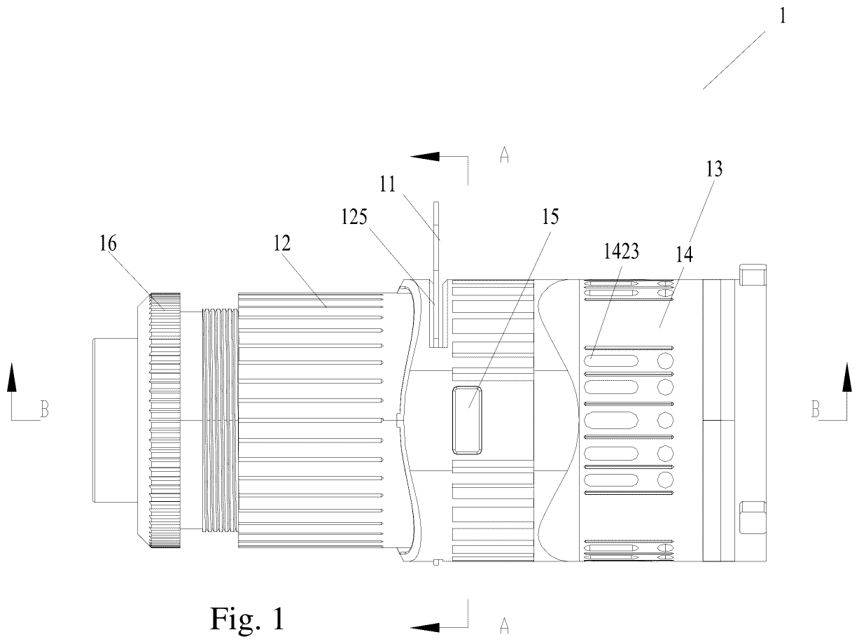

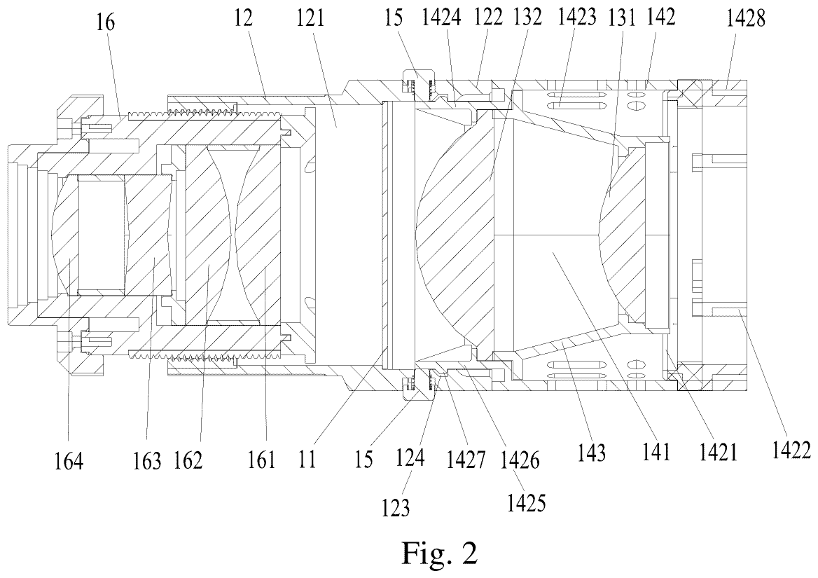

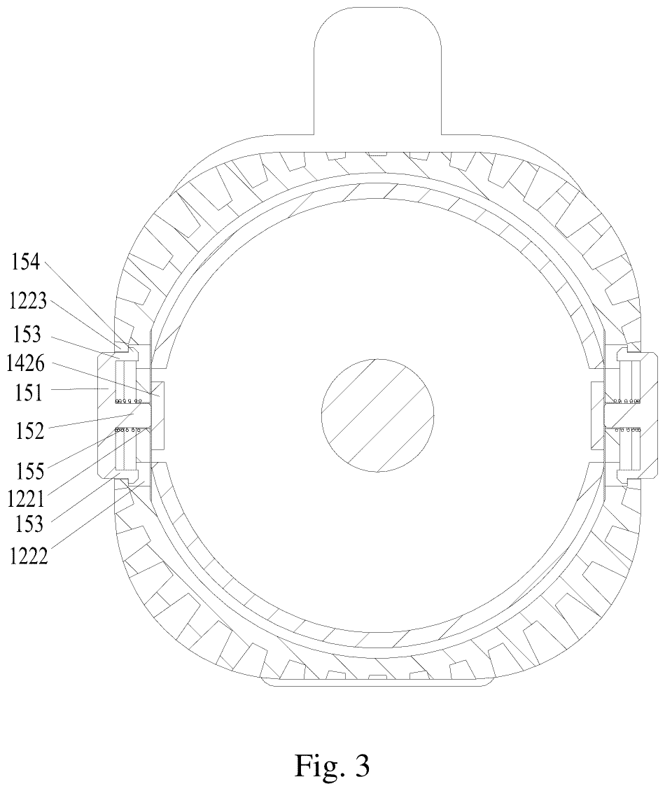

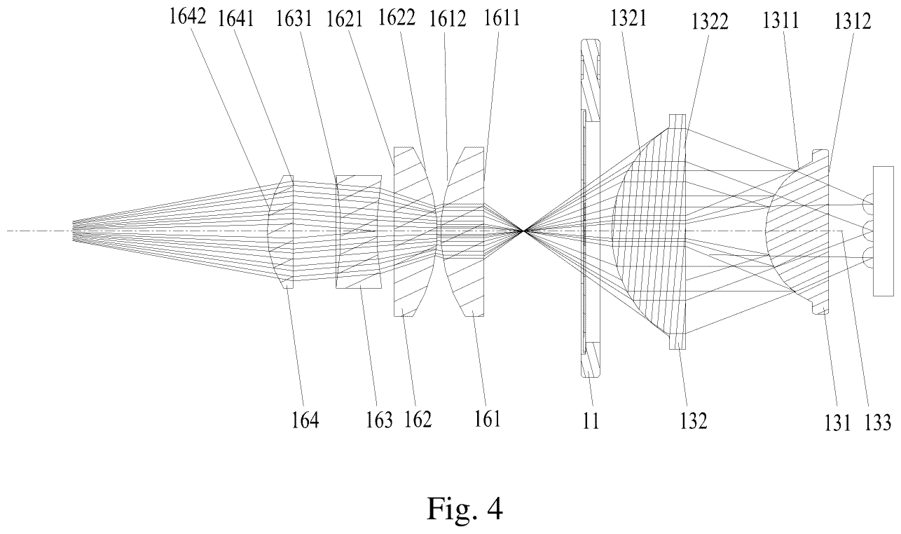

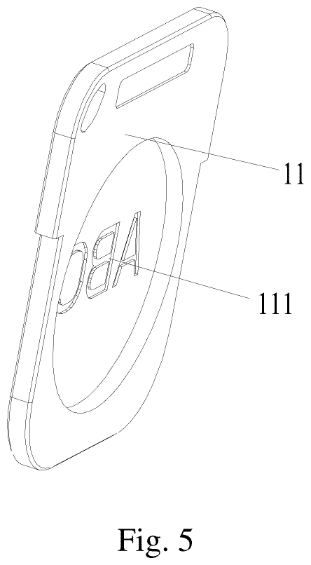

With reference to FIGS. 1-5, Example 1 of the present invention is a snoot 1, wherein the snoot 1 includes an imaging negative film 11, a mounting tube 12, and an optical glass module 13;

In the embodiment, the optical glass module 13 includes:
a first lens 131 for being close to a light source to focus light rays from the light source;
a second lens 132 for focusing light rays passing through the first lens 131;
the positions of the first lens 131 and the second lens 132 correspond to each other; and a light-focusing path 133 is formed from the first lens 131 to the lens 132.

In the embodiment, the first lens 131 and the second lens 132 are both convex lenses.

In the embodiment, two sides of the first lens 131 are a first lens convex surface 1311 and a first lens plane 1312 close to the light source, respectively; two sides of the second lens 132 are respectively a second lens convex surface 1321 and a second lens plane 1322; the first lens convex surface 1321 corresponds to the second lens plane 1322.

In the embodiment, the optical glass module 13 further includes a condenser lens tube 14, the condenser lens tube 14 is provided with a light-focusing channel 141 therein, and the first lens 131 and the second lens 132 are respectively provided at two ends of the light-focusing channel 141.

In the embodiment, the light-focusing channel 141 increases in diameter from the first lens 131 to the second lens 132.

In the embodiment, a mounting channel 121 is provided in the mounting tube 12, one end of the mounting channel 121 is sleeved on one end of the condenser lens tube 14, the imaging negative film 11 is provided in the mounting tube 12, and the light-gathering path 133 passes through the mounting channel 121 and passes through the image-forming negative plate 11.

In the embodiment, the imaging negative film 11 is provided with a projected pattern 111 consisting of a plurality of through-holes.

In the embodiment, the condenser lens tube 14 includes a lampshade 142 and a lens tube 143, the light-focusing channel 141 is provided in the lens tube 143, the lampshade channel 1421 is provided in the lampshade 142, and the lens tube 143 is provided in the lampshade channel 144; one end of the mounting channel 121 is sleeved on one end of the lampshade 142, the other end of the lampshade 142 is formed with a light source port 1422 for providing a light source, the lampshade channel 1421 is in communication with the light source port 1422, and the light source port 1422 corresponds to the first lens 131.

In the embodiment, the other end of the lampshade 142 is detachably provided with a light source connector 1428, and the light source port 1422 for providing a light source is formed at the light source connector 1428; the detachable connection can be realized through screws, and different light source connectors 1428 can be replaced to adapt to different models and sizes of external light source structures.

In the embodiment, the lampshade 142 is provided with a plurality of lampshade heat dissipation holes 1423 penetrating to the lampshade channel 1421, and the plurality of lampshade heat dissipation holes 1423 surround the lampshade 142 and all correspond to the lens tube 143.

In the embodiment, one end of the lampshade 142 is provided with a first clamping end 1424, one end of the mounting tube 12 is provided with a second clamping end 122, the second clamping end 122 is an end corresponding to one end of the mounting channel 121, the first clamping end 1424 is provided with a first clamping structure 1245, the second clamping end 122 is provided with a second clamping structure 123, the second clamping end 122 is sleeved on the first clamping end 1424, and the first clamping structure 1425 is detachably clamped with the second clamping structure 123; the first clamping end 1424 and the second clamping end 122 are further provided with a quick release button 15 for controlling the first clamping structure 1245 and the second clamping structure 123 to be disengaged from clamping.

In the embodiment, the quick release button 15 is movably provided on the second clamping end 122, and the quick release button 15 passes through the second clamping end 122 to connect with the first clamping structure 1425.

In the embodiment, the first clamping structure 1425 includes an elastic clamping body 1426, the elastic clamping body 1426 is provided with a clamping protrusion 1427, the second clamping structure 123 includes a clamping groove 124, the clamping protrusion 147 is detachably clamped into the clamping groove 124, and the quick release button 15 passes through the second clamping end 122 and then abuts on the elastic clamping body 1426 so as to correspond to the position of the clamping protrusion 147.

In the embodiment, the quick release button 15 includes a button part 151, an abutting part 152, and two limiting parts 153, wherein the two limiting parts 153 are respectively fixedly provided at two ends of one side of the button part 151, and the abutting part 152 is fixedly provided in the middle of one side of the button part 151; an abutting through-hole 1221 and two limiting through-holes 1222 are provided on the second clamping end 122, the abutting part 152 passes through the abutting through-hole 1221 to abut against the elastic clamping body 1426, the two limiting parts 153 are respectively movably provided in the two limiting through-holes 1222, and a first anti-releasing part 154 for preventing the quick release button 15 from disengaging from the second clamping end 122 is provided on the limiting part 153, a second anti-releasing part 1223 is provided in the limiting through-hole 1222, and the positions of the first anti-releasing part 154 and the second anti-releasing part 1223 correspond to each other.

In the embodiment, a return spring 155 is further provided between the button part 151 and the second clamping end 122, the return spring 155 is sleeved on the abutting part 152, and both ends of the return spring 155 respectively abut the button part 151 and the second clamping end 122.

In the embodiment, the quick release button 15 is formed of a plastic material.

In the embodiment, the mounting tube 12 is provided with an insertion slot 125 penetrating to the mounting channel 121, and the imaging negative film 11 is detachably inserted into the mounting channel 121 through the insertion slot 125.

In the embodiment, an extended optical glass module 16 is movably provided at the other end of the mounting channel 121.

In the embodiment, the extended optical glass module 16 includes a third lens 161, a fourth lens 162, a fifth lens 163 and a sixth lens 164; two sides of the third lens 161 are respectively a third optical glass plane 1611 and a third optical glass convex surface 1612; the fourth lens 162 includes a fourth optical glass plane 1621 and a fourth optical glass convex surface 1622; two sides of the fifth lens 163 are respectively a fifth optical glass concave surface 1631; two sides of the sixth lens 164 are respectively a sixth optical glass plane 1641 and a sixth optical glass concave surface 1642; the light-focusing path 133 sequentially passes through the third optical glass plane 1611, the third optical glass convex surface 1612, the fourth optical glass convex surface 1622, the fourth optical glass plane 1621, the fifth optical glass concave surface 1631 on one side of the fifth lens 163, the fifth optical glass concave surface 1631 on the other side of the fifth lens 163, the sixth optical glass plane 1641, and the sixth optical glass convex surface 1642.

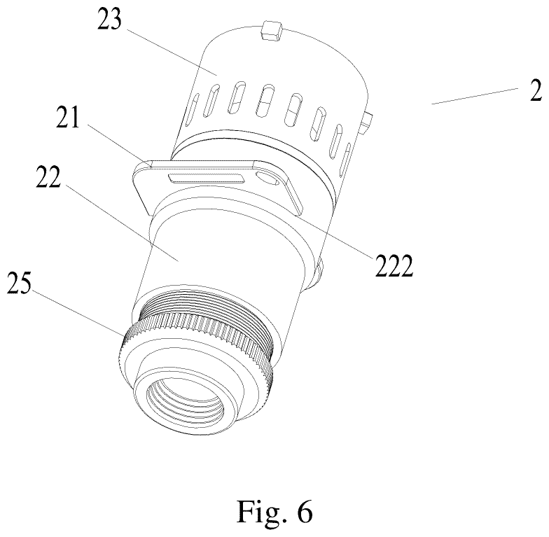

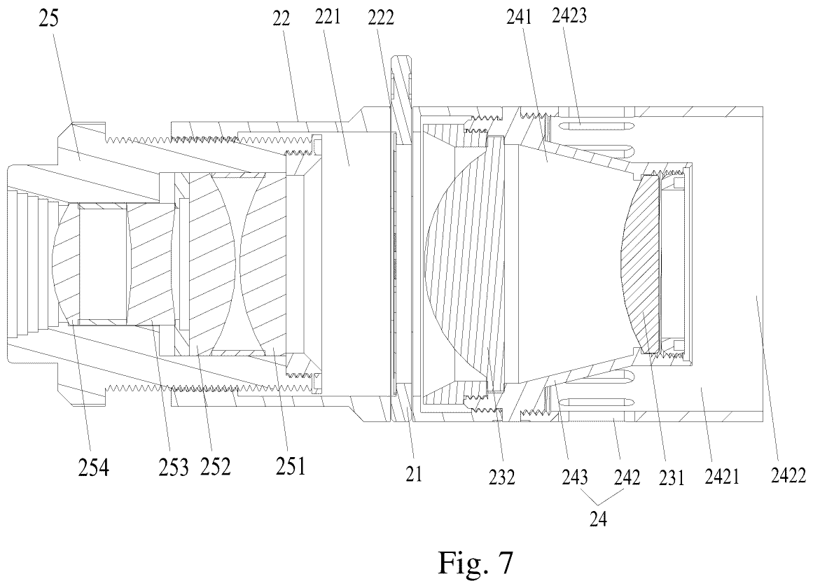

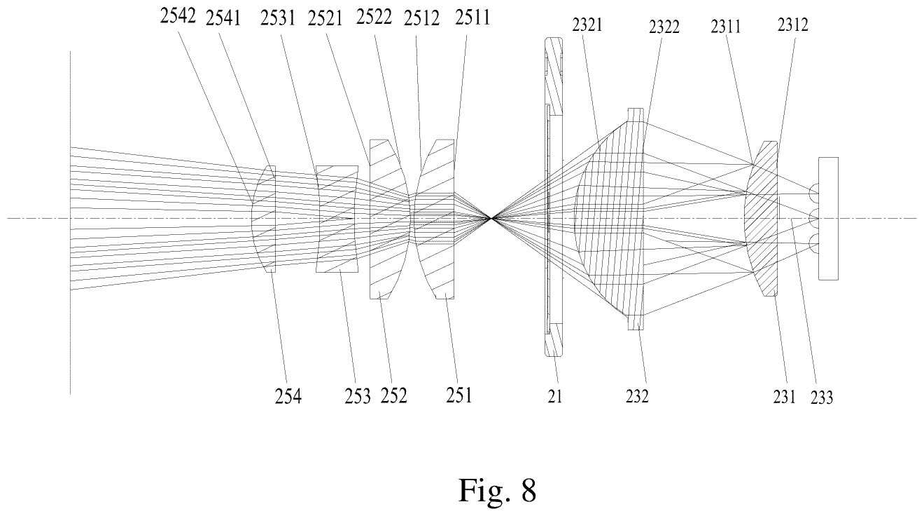

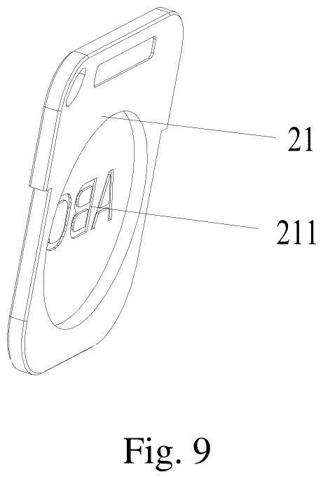

With reference to FIGS. 6-9, Example 2 of the present invention is a snoot 2, wherein the snoot 2 includes an imaging negative film 21, a mounting tube 22, and an optical glass module 23;
in the embodiment, the optical glass module 23 includes:
a first lens 231 for being close to a light source to focus light rays from the light source;
a second lens 232 for focusing light rays passing through the first lens 231;
the positions of the first lens 231 and the second lens 232 correspond to each other; and a light-focusing path 233 is formed from the first lens 231 to the lens 232.

In the embodiment, the first lens 231 and the second lens 232 are both convex lenses.

In the embodiment, two sides of the first lens 231 are a first lens convex surface 2311 and a first lens plane 2312 close to the light source, respectively; two sides of the second lens 232 are respectively a second lens convex surface 2321 and a second lens plane 2322; the first lens convex surface 2311 corresponds to the second lens plane 2322.

In the embodiment, the optical glass module 23 further includes a condenser lens tube 24, the condenser lens tube 24 is provided with a light-focusing channel 241 therein, and the first lens 231 and the second lens 232 are respectively provided at two ends of the light-focusing channel 241.

In the embodiment, the light-focusing channel 241 increases in diameter from the first lens 231 to the second lens 232.

In the embodiment, a mounting channel 221 is provided in the mounting tube 22, one end of the mounting channel 221 is sleeved on one end of the condenser lens tube 24, the imaging negative film 21 is provided in the mounting tube 22, and the light-gathering path 233 passes through the mounting channel 221 and passes through the image-forming negative plate 21.

In the embodiment, the imaging negative film 21 is provided with a projected pattern 211 consisting of a plurality of through-holes.

In the embodiment, the condenser lens tube 24 includes a lampshade 242 and a lens tube 243, the light-focusing channel 241 is provided in the lens tube 243, the lampshade channel 2421 is provided in the lampshade 242, one end of the lens tube 243 extends into the lampshade channel 2421, and the lens tube 243 and one end of the lampshade channel 2421 are detachably connected via a thread; the other end of the lampshade channel 2421 is formed with a light source port 2422 for providing a light source, wherein the light source port 2422 corresponds to the first lens 231;
and one end of the mounting channel 221 is detachably sleeved on the other end of the lens tube 243 via a threaded structure.

In the embodiment, the lampshade 242 is provided with a plurality of lampshade heat dissipation holes 2423 penetrating to the lampshade channel 2421, and the plurality of lampshade heat dissipation holes 2423 surround the lampshade 242 and all correspond to the lens tube 243.

In the embodiment, the mounting tube 22 is provided with an insertion slot 222 penetrating to the mounting channel 221, and the imaging negative film 21 is detachably inserted into the mounting channel 221 through the insertion slot 222.

In the embodiment, an extended optical glass module 25 is movably provided at the other end of the mounting channel 221.

In the embodiment, the extended optical glass module 25 includes a third lens 251, a fourth lens 252, a fifth lens 253 and a sixth lens 254; two sides of the third lens 251 are respectively a third optical glass plane 2511 and a third optical glass convex surface 2512; the fourth lens 252 includes a fourth optical glass plane 2521 and a fourth optical glass convex surface 2522; two sides of the fifth lens 253 are respectively a fifth optical glass concave surface 2531; two sides of the sixth lens 254 are respectively a sixth optical glass plane 2541 and a sixth optical glass concave surface 2542; the light-focusing path 133 sequentially passes through the third optical glass plane 2511, the third optical glass convex surface 2512, the fourth optical glass convex surface 2522, the fourth optical glass plane 2521, the fifth optical glass concave surface 2531 on one side of the fifth lens 253, the fifth optical glass concave surface 2531 on the other side of the fifth lens 253, the sixth optical glass plane 2541, and the sixth optical glass convex surface 2542.

The foregoing is merely a preferred embodiment of the invention and is not to be construed as limiting the invention. Thus, it is intended that the present invention cover the modifications, equivalents, and alternatives falling within the spirit and scope of the invention.

1. An optical glass module, comprising:
a first lens for being close to a light source to focus light rays from the light source;
a second lens for focusing light rays passing through the first lens;
the positions of the first lens and the second lens corresponding to each other; and a light-focusing path being formed from the first lens to the second lens.

2. The optical glass module of claim 1, wherein the first lens and the second lens are convex lenses.

3. The optical glass module of claim 2, wherein two sides of the first lens are respectively a convex surface of the first lens and a plane of the first lens close to the light source; two sides of the second lens are respectively a convex surface of the second lens and a plane of the second lens; the convex surface of the first lens corresponds to the plane of the second lens.

4. The optical glass module of claim 3, further comprising a condenser lens tube having a light-focusing channel provided therein, wherein both the first lens and the second lens are provided in the light-focusing channel.

5. The optical glass module of claim 4, wherein the light-focusing channel increases in diameter from the first lens to the second lens.

6. A snoot, comprising an imaging negative film, a mounting tube, and the optical glass module of claim 5, wherein a mounting channel is provided in the mounting tube, one end of the mounting channel is sleeved on one end of the condenser lens tube, the imaging negative film is provided in the mounting tube, and the light-focusing path passes through the mounting channel and through the imaging negative film.

7. The snoot of claim 6, wherein the imaging negative film is provided with a projected pattern of a plurality of through-holes.

8. The snoot of claim 6, wherein the condenser lens tube comprises a lampshade and a lens tube, the light-focusing channel is provided in the lens tube, a lampshade channel is provided in the lampshade, and the lens tube is provided in the lampshade channel; one end of the mounting channel is sleeved on one end of the lampshade, the other end of the lampshade is formed with a light source port for providing a light source, and the light source port corresponds to the first lens.

9. The snoot of claim 8, wherein a plurality of lampshade heat dissipation holes penetrating to the lampshade channel are provided on the lampshade, and the plurality of lampshade heat dissipation holes surround the lampshade and all correspond to the lens tube.

10. The snoot of claim 9, wherein one end of the lampshade is provided with a first clamping end, one end of the mounting tube is provided with a second clamping end, a first clamping structure is provided at the first clamping end, a second clamping structure is provided at the second clamping end, the second clamping end is sleeved on the first clamping end, and the first clamping structure and the second clamping structure are detachably clamped; the first clamping end and the second clamping end are further provided with a quick release button for controlling the first clamping structure and the second clamping structure to be disengaged from clamping.

11. The snoot of claim 10, wherein the quick release button is movably provided on the second clamping end, and the quick release button passes through the second clamping end to connect with the first clamping structure.

12. The snoot of claim 11, wherein the first clamping structure comprises an elastic clamping body, the elastic clamping body is provided with a clamping protrusion, the second clamping structure comprises a clamping groove, the clamping protrusion is detachably clamped into the clamping groove, and the quick release button passes through the second clamping end and abuts the elastic clamping body to correspond to the position of the clamping protrusion.

13. The snoot of claim 12, wherein the quick release button comprises a button part, an abutting part, and two limiting parts, wherein the two limiting parts are respectively fixedly provided at two ends of one side of the button part, and the abutting part is fixedly provided in the middle of one side of the button part; an abutting through-hole and two limiting through-holes are provided on the second clamping end, the abutting part passes through the abutting through-hole so as to abut the elastic clamping body, the two limiting parts are respectively movably provided in the two limiting through-holes, a first anti-releasing part to prevent the quick release button from disengaging from the second clamping end is provided on the limiting part, a second anti-releasing part is provided in the limiting through-hole, and the positions of the first anti-releasing part and second anti-releasing part correspond to each other.

14. The snoot of claim 13, wherein a return spring is further provided between the button part and the second clamping end, the return spring is sleeved on the abutting part, and both ends of the return spring abut the button part and the second clamping end, respectively.

15. The snoot of claim 10, wherein the quick release button is made of a plastic material.

16. The snoot of claim 6, wherein the condenser lens tube comprises a lampshade and a lens tube, the light-focusing channel is provided in the lens tube, the lampshade channel is provided in the lampshade, one end of the lens tube extends into the lampshade channel, and the lens tube is detachably connected to one end of the lampshade channel; the other end of the lampshade channel is formed with a light source port for providing a light source, and the light source port corresponds to the first lens;
and one end of the mounting channel is detachably sleeved on the other end of the lens tube via a threaded structure.

17. The snoot of claim 16, wherein a plurality of lampshade heat dissipation holes penetrating to the lampshade channel are provided on the lampshade, and the plurality of lampshade heat dissipation holes surround the lampshade and all correspond to the lens tube.

18. The snoot of claim 6, wherein the mounting tube is provided with an insertion slot therethrough to the mounting channel, and the imaging negative film is detachably inserted into the mounting channel through the insertion slot.

19. The snoot of claim 6, wherein an extended optical glass module is movably provided at the other end of the mounting channel.

20. The snoot of claim 19, wherein the extended optical glass module comprises a third lens, a fourth lens, a fifth lens, and a sixth lens; two sides of the third lens are respectively a third optical glass plane and a third optical glass convex surface; the fourth lens comprises a fourth optical glass plane and a fourth optical glass convex surface; two sides of the fifth lens are both the fifth lens concave surfaces; two sides of the sixth lens are respectively a sixth optical glass plane and a sixth optical glass concave surface; the light-focusing path successively passes through the third optical glass plane, the third optical glass convex surface, the fourth optical glass convex surface, the fourth optical glass plane, the fifth optical glass concave surface on one side of the fifth lens, the fifth optical glass concave surface on the other side of the fifth lens, the sixth optical glass plane, and the sixth optical glass convex surface.
